(19) United States
(12) Patent Application Publication
(10) Pub. No.: US 2007/0130151 A1
(43) Pub. Date: Jun. 7, 2007

(54) Using errors to perform a search

(75) Inventor: Stephen L. Wiles, Everett, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/290,538

(22) Filed: Dec. 1, 2005

(51) Int. Cl. G06F 17/30

(52) U.S. Cl. 707/10

(57) ABSTRACT

The invention is directed towards a system and method for proving content to a user. The invention can be configured to present the content to the user if a user intentionally or unintentionally inputs an incorrect URL into an address field of a browser window instead of presenting the user with an error message. The incorrect URL can include a domain name along with any number of search terms. The invention can parse the incorrect URL to identify a URL that points to an existing content location of the requested content. Once the URL has been identified, the invention can map the identified URL to the search request unknowingly to the user.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

If a user is looking for a specific feature or subtopic on a website and does not know the exact URL that points to the feature or subtopic, a user may sometimes use the domain name of the website and add search terms along with the domain name as guesses in order to connect to the content location of the feature or subtopic. For example, if a user wanted to find out about the Small Business Server at website named “website.com”, the user may type in the URL “www.website.com/smallbusinessserver” into the address field of a browser window. Such a technique of guessing may work, however, in most cases this may not work and the user may be presented with a 404 error or a custom 404 error web page. To avoid receiving a 404 error, a user may be forced to know the right words, phrase, or abbreviations and the exact order to get a URL to point to the correct web page that corresponds to the feature or subtopic. This may be undesirable, however, as some URLs may be very long and can pose as a serious challenge for a user to remember.

Conventional methods for solving this problem only allow for requested URLs that include subdomains to be compared to a database of known mappings between subdomains and subdirectories. If there is a matching entry in the database, then the requested URL can be redirected to the matching subdirectory. However, this method is limited as a user can only enter a requested URL that includes a subdomain, and the requested URL is mapped to a proper subdirectory only if the match is found in the database. Moreover, the user is not able to freely include any number and any type of search terms within the requested URL in order to perform a search for a subtopic or feature within on a server that corresponds the domain name of the URL.

Another problem that can arise is when a user attempts to access a URL that has been saved as a favorite that is no longer valid. If a user attempts to access a saved URL in which the content that the saved URL points to has, for example, moved to a different location, the user may be presented with a 404 error or a 404 error custom web page. This can be undesirable as well because the user is now forced to perform a subsequent search to find the updated URL that points to the desired content.

### SUMMARY

A system and method are disclosed for providing content to a search requester. The method can include receiving a search request for content, wherein the search request includes a requested URL that does not correspond to an existing content location. The method can further include identifying an URL that corresponds to a document corresponding to the existing content location. Additionally, the method can include providing the document once the corresponding URL has been identified.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system to provide content to a client.

FIG. 2 illustrates an embodiment of a method for providing requested content to a user when the user commits an error.

### DETAILED DESCRIPTION

The invention can be configured to provide content to a user when a user submits a search request by inputting a URL into an address field of a browser window that does not correspond to an existing content location. The content can be, for example, a document such as a web page that includes any type of information desired by the user. The invention can allow a user to submit a search request for content by inputting a domain name along with any number of search terms after the domain name as the customized URL. The invention can allow the user to enter any type of domain name and any type of search terms. The invention can be configured to parse the customized URL included in the search request in order to identify a proxied URL that points to a correct location of the content that the user wants to access. The invention can then map the search request to the proxied URL that corresponds to the location of the content and can then provide the content to the user.

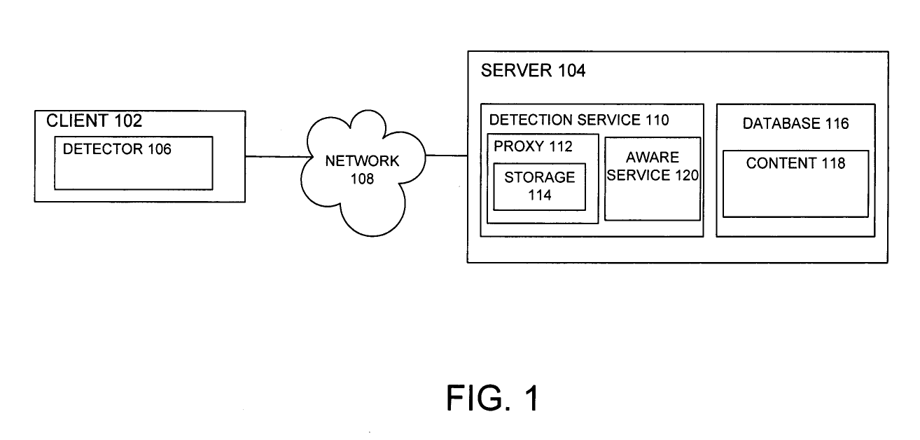

FIG. 1 is an embodiment of a system to provide content to a client. Client 102 may be or include a desktop or laptop computer, a network-enabled cellular telephone, wireless email client, or other client, machine or device to perform various tasks including Web browsing, search, electronic mail (email) and other tasks, applications and functions. Client 102 may additionally be any portable media device such as digital still camera devices, digital video cameras, media players such as personal music players and personal video players, and any other portable media devices. Client 102 can include a communication interface. The communication interface may be an interface that can allow the client to be directly connected to any other client or device or allows the client 102 to be connected to a server, another client, or device over network 108. Network 108 can include, for example, a local area network (LAN), a wide area network (WAN), or the Internet. In an embodiment, the client 102 can be connected to another client or device via a wireless interface.

Sever 104 may also be or can include a machine including, for instance, a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. In an embodiment, server 104 can be a website. Moreover, in an embodiment, client 102 can be another server.

Server 104 can include detection service 110, proxy 112, and database 116. Detection service 110 can be utilized to detect any number of errors committed by client 102 when requesting content from server 104. In an embodiment, detection service 110 can be a 404 detection service that can detect 404 errors committed by client 102 when requesting content from server 104. Proxy 112 can be used to retrieve any type of content 118 stored in database 116 that corresponds to a search request received from a client 102. In an embodiment, detection service 110 can also include an aware service 120 that can detect any number of detection services stored on one or more other servers. In an embodiment, client 102 can include a detector 106 that can detect and recognize a detection service 110 stored on a server 104.

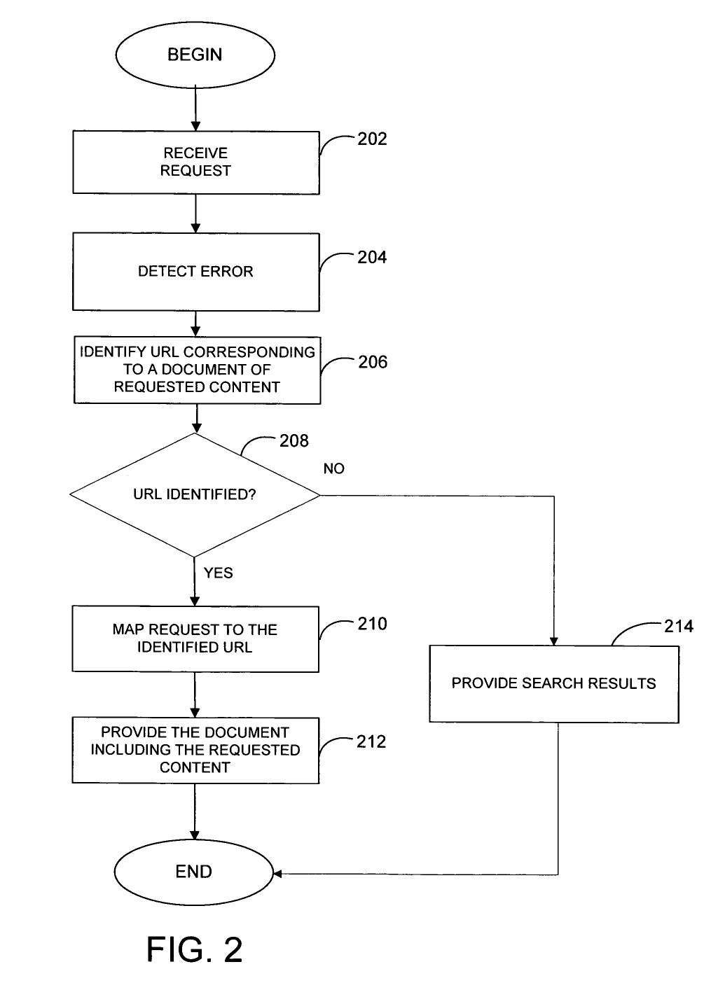

FIG. 2 is an embodiment of a method for providing requested content to a user when the user commits an error. The invention can be configured to recognize any type of errors including, but not limited to, 300, 301, 302, 303, 306,307, 401,402, 403, 407, 408, 409, 500, and 503 errors. In an embodiment, another type of error that is recognized is a 404 error. In such an embodiment, the invention can be configured to present a user with content that corresponds to a search request for the content from the user instead of presenting the user with a 404 error page when the user intentionally or unintentionally enters an incorrect address into an address field of a browser. A server can receive a search request for content from a user at step 202. The search request can include a customized URL that may not correspond to an existing content location. For example, the user can input the customized URL into an address field of a browser that can correspond to a type of content that the user is interested in obtaining. The customized URL can include a domain name along with any number of search terms that correspond to the requested content. The invention can allow the user to enter any type of domain name and any type of search terms. For example, a user who is interested in searching for the “John Madden Football 2006” videogame at “bestbuy.com” may arbitrarily enter a customized URL of www.bestbuy.com/videogames/xbox2/football/johnmadden2006 into an address field that includes the domain name of “bestbuy.com” and the search terms “videogames,” “xbox2,” “football,” and “johnmadden2006.” The customized URL may or may not map to an existing content location stored on the server that manages the bestbuy.com website. If the customized URL does not map to an existing content location, then a detection service that is stored on the server can detect the 404 error corresponding to the inputted customized URL at step 204.

Once the 404 error is detected, the server can then begin to identify a URL that corresponds to a document that includes the requested content at step 206 instead of presenting a the user with a 404 error page. The detection service can begin to identify and search for an the URL of an existing content location that corresponds to the requested content by parsing the customized URL that includes the search terms inputted by the user. In parsing the customized URL, the detection service can take the search terms and either rearrange the order of the search terms, attempt to look for synonyms to the search terms, or execute any other method of configuring the search terms in order to search for the URL of the existing content location that corresponds to the requested content. At step 208, the detection service makes a determination whether the URL has been identified that corresponds to the existing location of the requested content. In an embodiment, if the existing content location cannot be found that corresponds to customized URL, at step 214 the server can be configured to provide a web page of search results from a search engine, wherein the search results can be associated with the customized URL.

If the detection service is able to find an existing content location for the requested content in the customized URL, the detection service can, with the aide of the proxy 112 (FIG. 1), map the search request to the identified existing content location. The identified existing content location can have a proxied URL that corresponds to the actual location of the content. The proxy can then retrieve the requested content from the identified content location. In retrieving the requested content, the proxy can alter the proxied URL and any other URLs within the content to point to the customized URL that the user initially entered into the address field of their browser. The client and the user may not have any knowledge of the detection service altering the proxied URL to point to the customized URL created by the user. From the point of reference of the client and the user, the customized URL entered by the user is the actual URL that points to the location of the requested content. For example, if the user entered the customized URL www.bestbuy.com/videogames/xbox2/football/johnmadden2006 to receive information regarding the videogame John Madden Football 2006 from the bestbuy.com website, even if the customized URL the user entered is not the actual URL that points to the content location of the requested content, the user and client may not know this because the customized URL may not change in the address field of the browser and thus the user and the client may not know that the detection service altered the proxied/actual URL to point to the customized URL. The proxy can store the customized URL in storage 114 (FIG. 1) for the duration of the session between the client and the server.

With the invention, more than one customized URL may be able to point to the same proxied URL. For example, a first customized URL www.bestbuy.com/videogames/xbox2/football/johnmadden2006 may point to a web page showing information regarding the videogame John Madden Football 2006, and a second customized URL www.bestbuy.com/xbox/madden06 can be parsed by the detection service to lead the detection service to identify and point to the same web page regarding the videogame.

The user can store the customized URL as a favorite on the client that he/she is using in order to access the customized URL at a later time. When the user accesses the customized URL at later time, a method for providing requested content to a user as detailed in FIG. 2 can be invoked again, wherein a subsequent access of the customized URL can be treated as a second search request that includes the same stored customized URL. The second search request that includes the same customized URL can then point to the same existing content location without the user's or the client's knowledge. If the content location of the requested content has moved after the user has saved the customized URL, when the user accesses the customized URL at a later time, the detection service can locate and identify the updated location of the content as detailed in step 206. In an embodiment, if the client includes a detector 106 (FIG. 1), the detection service can notify the client when the customized URL, that is stored as a favorite, is no longer valid. For example, if the content that corresponds to the customized URL is moved to another location, the detection service can notify the client that the customized URL is no longer valid. The client may then give the user the option of updating the saved customized URL. In such an embodiment, the client can interact with other stored applications through one or more APIs that can allow the user to update saved customized URLs in other documents.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. A method for providing content to a search requester, comprising:
receiving a search request for content, the search request including a requested URL that does not correspond to an existing content location;
identifying an URL that corresponds to a document corresponding to the existing content location; and
providing the document.

2. The method according to claim 1, wherein the search request is mapped to the identified URL.

3. The method according to claim 2, wherein the requested URL is a first URL that includes a domain name and at least one search term.

4. The method according to claim 3, wherein the requested URL is a second URL that includes the domain name and at least one search term different from the first URL, wherein the search request including the second URL is mapped to the same identified URL as the search request including the first URL.

5. The method according to claim 1, further comprising providing search results if the URL cannot be identified.

6. The method according to claim 1, wherein the requested URL is a previously saved URL, the previously saved URL being a URL that does not correspond to an existing content location and that has previously been mapped to the identified URL.

7. The method according to claim 6, further comprising mapping the previously saved URL to an updated URL, wherein the updated URL corresponds to a location of the document that is different than the existing content location.

8. The method according to claim 1, wherein identifying the URL comprises parsing the requested URL.

9. A method for providing content to a search requester, comprising:
receiving a first search request for content including a requested URL that does not correspond to an existing content location;
identifying an URL that corresponds to a document corresponding to the existing content location;
mapping the first search request to the identified URL;
receiving a second search request containing the requested URL of the first search request; and
providing the document.

10. The method according to claim 8, wherein the requested URL is a first URL that includes a domain name and at least one search term.

11. The method according to claim 10, wherein the requested URL is a second URL that includes the domain name and at least one search term different from the first URL, wherein the search request including the second URL is mapped to the same identified URL as the search request including the first URL.

12. The method according to claim 8, further comprising providing search results if the URL cannot be identified.

13. The method according to claim 8, wherein the requested URL in the second search request is a previously saved URL, the previously saved URL being a URL that does not correspond to an existing content location and that has previously been mapped to the identified URL.

14. The method according to claim 13, further comprising mapping the previously saved URL to an updated URL, wherein the updated URL corresponds to a location of the document that is different than the existing content location.

15. One or more computer-readable media having computer-usable instructions stored thereon for performing a method for providing content to a search requester, comprising:
receiving a search request for content, the search request including a requested URL that does not correspond to an existing content location;
identifying an URL that corresponds to a document corresponding to the existing content location; and
providing the document.

16. The computer-readable media according to claim 15, wherein the requested URL is a first URL that includes a domain name and at least one search term.

17. The computer-readable media according to claim 16, wherein the requested URL is a second URL that includes the domain name and at least one search term different from the first URL, wherein the search request including the second URL is mapped to the same identified URL as the search request including the first URL.

18. The computer-readable media according to claim 15, further comprising providing search results if the URL cannot be identified.

19. The computer-readable media according to claim 15, wherein the requested URL is a previously saved URL, the previously saved URL being a URL that does not correspond to an existing content location and that has previously been mapped to the identified URL.

20. The computer-readable media according to claim 19, further comprising mapping the previously saved URL to an updated URL, wherein the updated URL corresponds to a location of the document that is different than the existing content location.
